(19) United States
(12) Patent Application Publication
(10) Pub. No.: US 2013/0305012 A1
(43) Pub. Date: Nov. 14, 2013

(54) IMPLEMENTATION OF COUNTERS USING TRACE HARDWARE

(71) Applicant: Allen Hopley, Metcalfe (CA)

(72) Inventor: Allen Hopley, Metcalfe (CA)

(73) Assignee: Telefonaktiebolaget L M Ericsson (Publ), Stockholm (SE)

(21) Appl. No.: 13/468,670

(22) Filed: May 10, 2012

(51) Int. Cl. G06F 15/76

(52) U.S. Cl. 712/32; 712/E09.001

(57) ABSTRACT

A multi-core computing system includes a plurality of processor cores, a counter, and a register block including a plurality of event registers coupled to the plurality of processor cores. Each of the plurality of processor cores is configured to write event records to the event registers, and the register block is configured to generate a serialized event stream including event records written to the event registers. The system further includes an event stream processor configured to receive the serialized event stream, to analyze the serialized event stream to identify a counter update event record in the serialized event stream, and to update the counter in response to the counter update event record.

### FIELD

The present inventive concepts relate to computing systems, and in particular relate to counters for computing systems.

### BACKGROUND

In embedded computing systems, counters are typically used to provide visibility into what tasks the system is performing, and how well it is doing those tasks. Counters can provide summary information about what events have happened in the past and how many times those events have happened, without keeping large volumes of detailed event information in the system or having to stream that event information out of the system. Specialized debug counters can measure the performance of hardware or the performance of an application in the system

Counters may be implemented using software, dedicated hardware, or a combination of software and hardware.

A multi-core system is a computing system with two or more independent processors (called “cores”). The multiple cores can run multiple instructions at the same time, increasing overall processing speed of the systems. The cores can execute a single program or multiple programs in parallel. Cores may or may not share cache memory, but each core in a multi-core system typically has access to the system's data bus. Multi-core processors are used in many applications, including general-purpose applications, embedded applications, network control, digital signal processing, and graphics processing.

In a multi-core system, the implementation of counters can be more difficult than in single core systems. The problem lies in the typical read/modify/write cycle of updating a counter value. If multiple cores try to update a counter at nearly the same time (with the second core reading the value before the first core has written its updated value), then the results may be incorrect (e.g., as if the first core never did a change at all).

For example, FIG. 1 illustrates a system 10 including multiple cores 12 that operate independently of one another. While performing their respective operations, the cores 12 may update counters 20 independently.

FIG. 2 illustrates updating of a counter (Counter 1) by two different cores (Core 1 and Core 2). As shown therein, Core 1 may read the value of the counter, calculate a new value for the counter, and then write an updated value to the counter. Core 2 may then read the updated value of the counter, calculate a new value for the counter, and then write a newly updated value to the counter.

FIG. 3 illustrates a problem that can occur with near-simultaneous updates of a counter by multiple cores. As shown therein, Core 1 may read the current value of counter 1 and calculate an updated value of the counter. Before Core 1 can write the updated counter value, Core 2 may read the current value of the counter and calculate an updated value of the counter. When Core 2 writes its updated value to the counter, it is as if the update by Core 1 never occurred. The updated value of the counter following these operations may therefore be incorrect.

Conventional solutions to this problem include the use of hardware or software semaphores (i.e., flags or tokens) which, when captured by one core, inhibit the reading of the counter value by a second core (or third core, etc.) until the previous core has completed its write operation. Other conventional approaches use spin locks, read-linked machine instructions, and/or specialized hardware counters which add the value on a data bus to the current value at the memory location specified on the address bus.

Using semaphores serializes the modification of counters at a cost to performance. The performance impact on a system of using semaphores increases with the number of cores.

Another possible approach is to create an instance of each counter for each core. This can avoid the need for mutual exclusion, as each counter instance is only ever modified by a particular core. However, this approach may require increased memory usage, with the impact increasing with the number of cores. Using specialized hardware counters may be efficient from a computing resource standpoint, but it may be difficult to know ahead of time how many counters will be needed in a system, and the inclusion of specialized hardware counters may increase the cost of a system and/or take up valuable space on the chip.

### SUMMARY

A multi-core computing system according to some embodiments includes a plurality of processor cores, a counter, and a register block including a plurality of event registers coupled to the plurality of processor cores. Each of the plurality of processor cores is configured to write event records to the event registers, and the register block is configured to generate a serialized event stream including event records written to the event registers. The system further includes an event stream processor configured to receive the serialized event stream, to analyze the serialized event stream to identify a counter update event record in the serialized event stream, and to update the counter in response to the counter update event record.

The counter update event record may include a COUNTER_ID field including a value that identifies a particular counter of a plurality of counters to which the counter update event record applies, and the event stream processor is configured to update the particular counter in response to the value of the COUNTER_ID field.

The computing system may further include a port configured to transmit information to an external device, and the event stream processor is configured to output counter update information through the port.

The counter update event record may include a TRACE_EVENT_ID field that contains a unique identifier of a trace event that is being written to the trace event register, a TRACE_EVENT_TYPE field that identifies a type of trace event that is being written, a COUNTER_ID field that identifies the counter, and a COUNTER_UPDATE field that provides an amount by which the counter is being updated.

The computing system may further include a trace event memory coupled to the serialized event stream and the event stream processor, wherein the trace event memory stores counter update event records output in the serialized event stream. The event stream processor may read counter update event records from the trace event memory.

The computing system may further include a plurality of counters and a plurality of event stream processors, wherein each of the event stream processors is configured to update a respective subset of the plurality of counters.

Each of the event stream processors may be coupled to the trace event memory and may be configured to process trace event records associated with its respective predefined subset of the plurality of counters.

Some embodiments provide methods of operating a multi-core computing system including a plurality of processor cores, a trace event register that is accessible by the plurality of processor cores, and at least one counter. The methods include writing a counter update event record from one of the plurality of processor cores to the trace event register, serializing the counter update event record in a serialized event stream that is output by the trace event register, analyzing the counter update event record to determine an identity of a counter that is to be updated and an amount by which the counter is to be updated, and updating the counter in response to the counter update event record.

The methods may further include writing the counter update event record from the serialized event stream into a trace event memory, wherein analyzing the counter update event includes reading the counter update event record from the trace event memory.

The methods may further include outputting the counter update event record through a port to an external device.

A computing system according to further embodiments includes a plurality of counters and a plurality of processor cores configured to generate counter update event records that each include a COUNTER_ID field including a value that identifies a particular counter of the plurality of counters to which the counter update event record applies and a COUNTER_UPDATE field that provides an amount by which the particular counter is being updated. The computing system further includes a register block including a plurality of event registers coupled to the plurality of processor cores, wherein each of the plurality of processor cores is configured to write event records to the event registers, and wherein the register block is configured to generate a serialized event stream including event records written to the event registers. The computing system further includes an event stream processor configured to read counter update event records from the serialized event stream, to analyze the counter update event records, and to update the first counter in response to the value of the COUNTER_ID field and the value of the COUNTER_UPDATE field in one of the counter update event records.

The computing system may further include a trace event memory coupled to the serialized event stream, wherein the trace event memory stores counter update event records output by the serialized event stream, and the event stream processor may be configured to read the counter update event records from the trace event memory.

The computing system may further include a plurality of event stream processors, wherein each of the event stream processors is configured to update a respective subset of the plurality of counters.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a block diagram of a multi-core system including a set of counters.

FIG. 2 is a flow diagram illustrating updating of a counter by multiple cores.

FIG. 3 is a flow diagram illustrating near-simultaneous updating of a counter by multiple cores in which an update error can occur.

FIG. 4 is a block diagram of a multi-core system including a set of counters in accordance with the inventive concepts.

FIG. 5 is a flowchart that illustrates operations of systems/methods for updating a counter in a multi-core system in accordance with the inventive concepts.

FIG. 6 is a block diagram of a multi-core system including a set of counters in accordance with further embodiments of the inventive concepts.

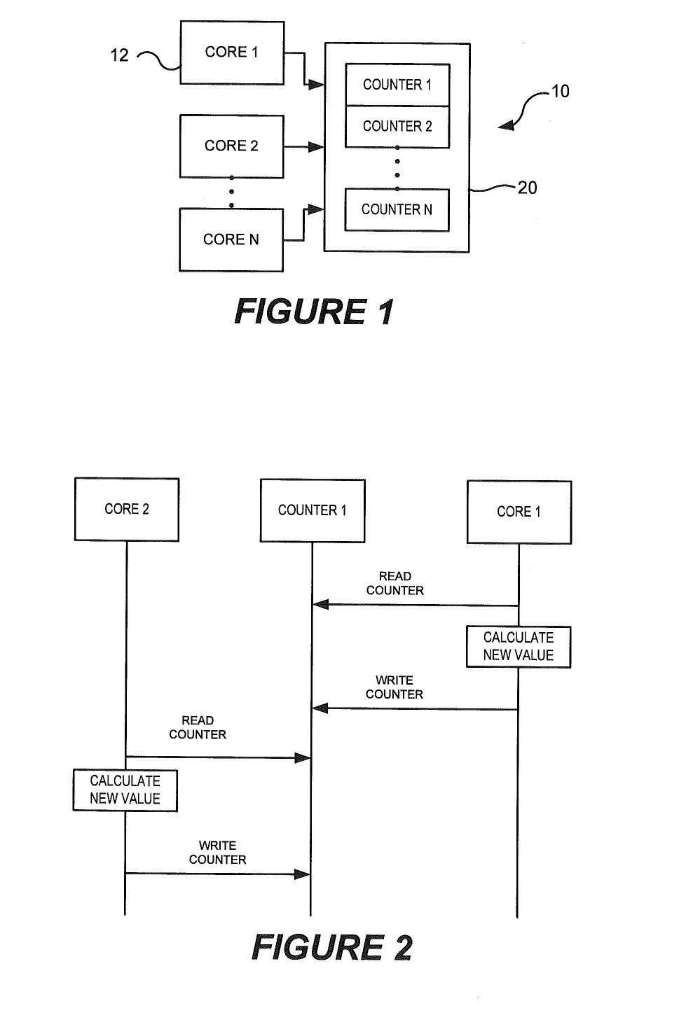

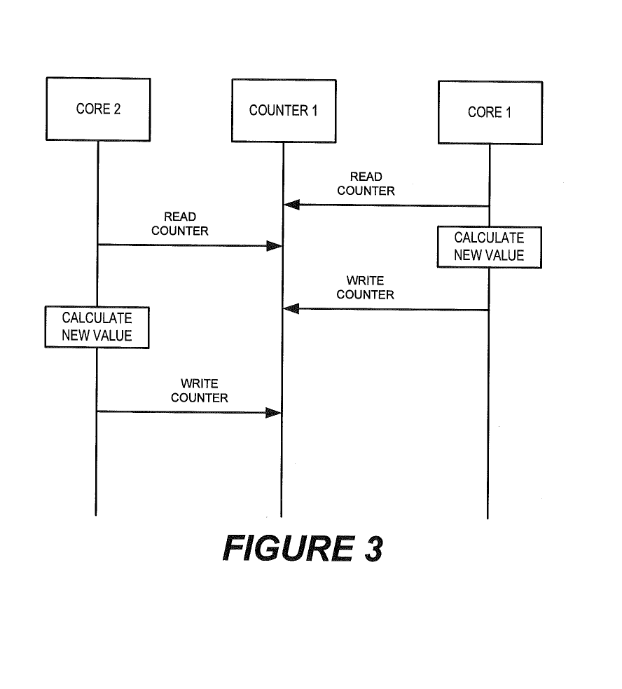

### DETAILED DESCRIPTION OF EMBODIMENTS

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Counters are not the only means to achieve visibility into an embedded system. Trace systems, which can stream event information out of the system, are also common. In fact, trace system interfaces have been standardized in the Nexus standard. Trace systems are typically a fundamental part of the hardware, and have support for combining the event streams from multiple cores into a single data stream. Some trace system have the ability to place the event stream into memory so that it can be processed within the system (to allow software involvement in the handling of the trace event stream).

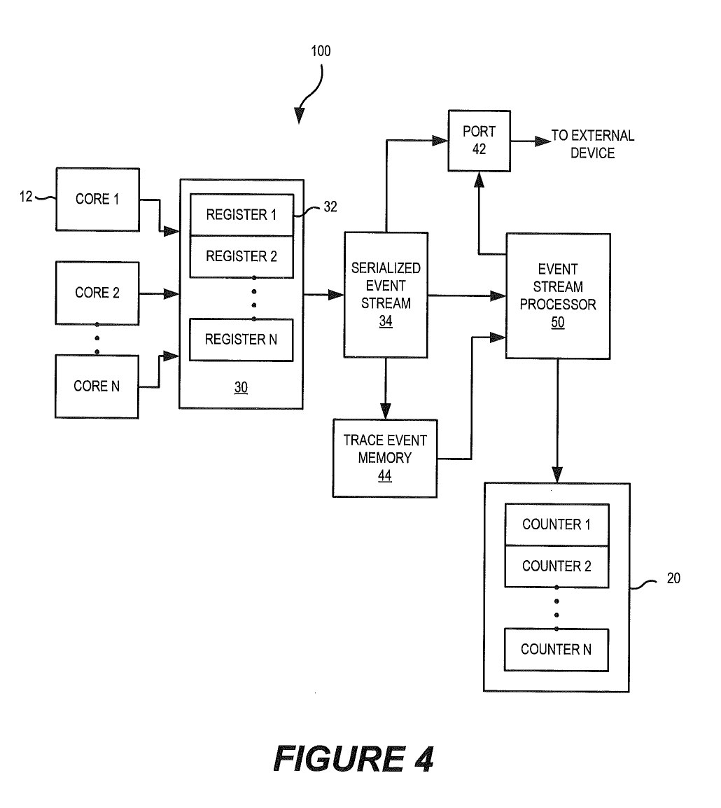

For example, referring to FIG. 4, a multi-core computing system 100 includes a plurality of cores 12. The computing system 100 includes a register block 30 that includes one or more hardware event registers 32 that are accessible by the cores 12, such that the cores 12 can post (write) events to the event registers 32. Events written to the event registers 32 are output to a serialized event stream 34, which is typically output through a port 42 for processing by an external processor.

The computing system 100 also includes a plurality of counters 20 that can be used to keep track of activities occurring within the system 100. During operation of the system 100, it is desirable for one or more of the cores 12 to update the counters 12 as events occur within the system 100.

Some embodiments of the present inventive concept use trace system hardware and internal software processing of the trace event stream to provide a means for updating counters. The trace event stream can be generated by on-chip debugging circuitry, such as debugging circuitry complying with the IEEE-ISTO 5001-2003 (Nexus) standard. Such an approach may avoid the need for mutual exclusion in the cores that generate the counter updates. This approach may also increase the efficiency of application counters in a multi-core compute platform by internally processing counter update information through the event data stream.

As shown in FIG. 4, an event stream processor 50 may be provided. The event stream processor 50, which may be implemented in software, hardware, and/or a combination of hardware and software, has access to the serialized event stream 34. The event stream processor 50 also has access to one or more counters 20.

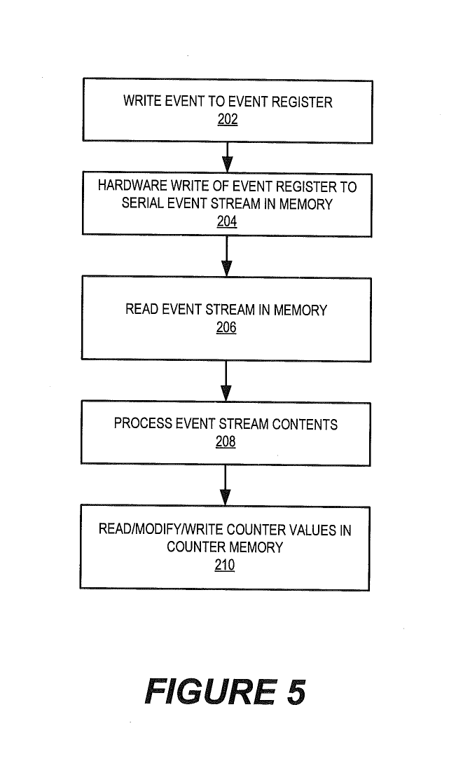

FIG. 5 is a flowchart of operations that can be performed in a system 100 as illustrated in FIG. 4. Referring to FIGS. 4 and 5, cores 12 write to trace hardware registers 32 that post events (block 202). The information written to the event register may identify both the counter that is to be modified and the amount by which the counter is to be modified. For example, the trace event record for a counter update may have the format:
[TRACE_EVENT_ID; TRACE_EVENT_TYPE; COUNTER_ID; COUNTER_UPDATE]
   where the TRACE_EVENT_ID field contains a unique identifier of the trace event that is being written to the trace event register 32, and TRACE_EVENT_TYPE field identifies the type of trace event that is being written. For example, the TRACE_EVENT_TYPE field may identify a particular trace event as being a counter update event. For counter update events, the field COUNTER_ID may identify the counter that is being updated, and COUNTER_UPDATE may provide the amount by which the counter is being updated. Other fields may also be included in the trace event record.

In some embodiments, the counter update event record may include the memory address of the counter to be updated. This would make it easy to have counters in different memory locations, and potentially within different types of memory (e.g., fast on-chip memory for fast-changing counters or slower external memory for counters which change more slowly). The COUNTER_ID field could refer to a particular counter within a single block of counters, and may, for example, include two parts to indicate a block amongst a set of blocks plus the counter within the identified block. In other embodiments, the COUNTER_ID field may include a direct memory address to indicate any memory address within the address space, or may include two parts that indicate a particular address space and an address within that identified address space.

The trace system performs a hardware write of the trace information to the serialized event stream 34, which serializes the events (block 204). The exact order of the counter events does not matter, since the typical operations performed on a counter are commutative (independent of order).

The trace system may also be configured to write the events to a trace event memory 44. The trace event memory 44 may be common memory that is accessible by the same type of core doing the increments and/or may be memory specific to a particular processor, such as a processor with access to more memory than is available in the common memory. The entire event data stream 34 could be stored in the trace event memory 44. Alternatively, only the counter update events may be stored in the trace event memory 44 based, for example, on the value of the TRACE_EVENT_TYPE field of the trace event.

The event in the event stream is then read by an event stream processor 50 from the trace event memory 44 or directly from the serialized event stream 34 (block 206) that has access to both the event stream memory and the counter memory. The event may then be processed by the event stream processor 50 (block 208).

In particular, the event stream processor 50 may identify the particular counter to be modified and find its memory or register location, read the current value of the counter, and perform an operation to calculate the new value of the counter (typically by adding the specified increment to the previous value). Finally the event stream processor 50 may write the new value of the counter back into counter memory (block 210).

Events identified as non-counter events can be handled as usual by the conventional event processing logic. For example, non-counter events can be processed as desired and may be output via the port 42 for external processing.

Counter events can also have additional handling. For example, counter events can also be streamed out of the system by the event stream processor 50 via port 42 for external processing, recordkeeping, monitoring, or other purposes.

Moreover, particular events can be handled in different manners. For example, information in a trace event could indicate an absolute value rather than an increment, and the handling could be to increment the number of occurrences of values within particular ranges of values (otherwise known as a histogram or data binning). In this case, the COUNTER_ID may refer not to a particular counter value, but to a set of bins corresponding to the number of occurrences of the counter within the corresponding ranges of the counter value.

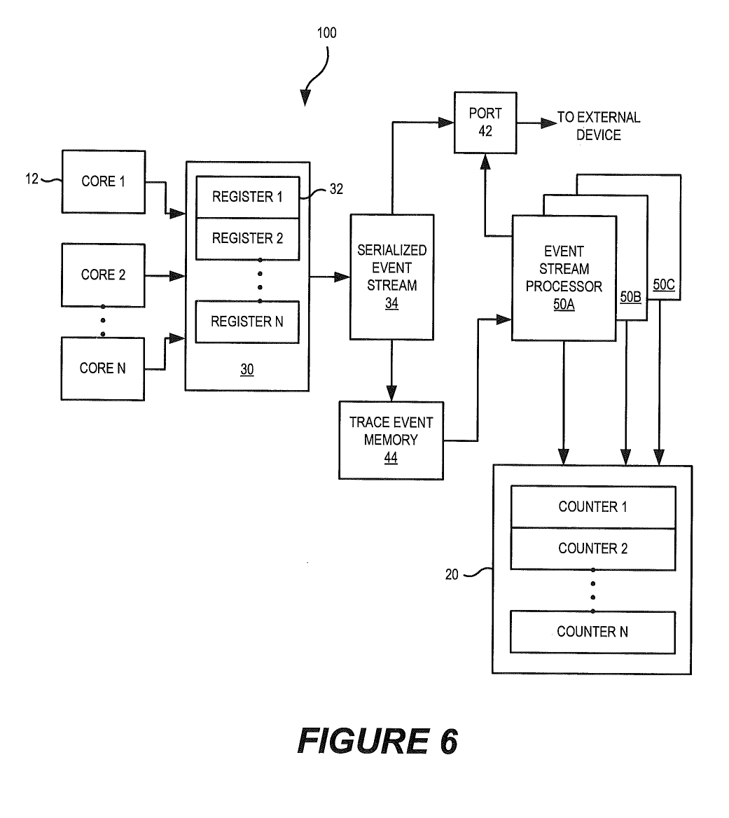

Referring to FIG. 6, in some embodiments, multiple event stream processors 50A, 50B, 50C, etc., may be provided. The use of multiple event stream processors may increase throughput of the handling of counter updates and/or other types of events. Each of the event stream processors 50A, 50B, 50C may have access to the trace event memory 44 and the counters 20.

In such embodiments, each of the event stream processors 50A, 50B, 50C may have exclusive access to one or more counters 20. For example, in some embodiments, each counter 20 can be assigned a unique ID. Each event stream processor 50A, 50B, 50C may process counter events for an identified set of counters. For example, event stream processor 50A could process counter events for counters 1-3, event stream processor 50B could process counter events for counters 4-6, event stream processor 50C could process counter events for counters 7-9, etc. Each event stream processor 50A, 50B, 50C could analyze all events generated in the serial event stream 34 and process only those counter events for the counters it is responsible for. Other counter events could be ignored.

Using trace hardware to perform counter handling can utilize existing hardware resources to perform counter handling in an efficient manner. It may avoid the need for mutual exclusion without increasing the memory size required to store the counters.

Furthermore, using common memory, such as the trace event memory 44, to store the event stream can allow multiple cores or a dedicated core to do the counter event processing.

Using a memory, such as the trace event memory 44, associated with specialized counters allows for larger, cheaper memory to be used. Common memory must have special logic to handle being accessed by multiple cores at the same time. In contrast, the event stream processors 50A, 50B, 50C can be implemented as software modules within a single core, and therefore do not require special logic to access the trace event memory.

The use of trace hardware to perform counter handling may be especially useful, because typically the trace hardware circuitry is already present in a system and normally is not used unless the system connected to an external device (usually in a lab).

Moreover, the trace hardware circuitry (namely, the event registers 32, and the serialized event stream 34) provides a highly efficient way to serialize events generated by multiple cores, with no requirement for mutual exclusion (i.e., the cores are not blocked waiting for access to a counter).

Counter increments are commutative (order independent), and deferrable, making the serialized data stream of the debugging circuitry a suitable solution for performing counter updates.

Some processors may include a high efficiency counter-specific memory that allows for serialized counter increments without explicit mutual exclusion. This may be done by putting data onto both the address and data busses at the same time, with the data being interpreted as an increment value, rather than an absolute value, so that the address and the incremental update amount are written at the same time. High efficiency mutual exclusion is provided by the busses. However, this approach does not break the counter increments down into a serialized stream for deferred processing, the memory area for updates is restricted.

Some embodiments of the present invention are described herein with reference to flowchart illustrations and/or block diagrams of methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a standalone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed typical embodiments of the invention and, although specific terms are employed, they are used in a generic and descriptive sense only and not for purposes of limitation, the scope of the invention being set forth in the following claims.

What is claimed is:

1. A multi-core computing system, comprising:
a plurality of processor cores;
a counter;
a register block including a plurality of event registers coupled to the plurality of processor cores, wherein each of the plurality of processor cores is configured to write event records to the event registers and wherein the register block is configured to generate a serialized event stream including event records written to the event registers; and
an event stream processor configured to receive the serialized event stream, to analyze the serialized event stream to identify a counter update event record in the serialized event stream, and to update the counter in response to the counter update event record.

2. The multi-core computing system of claim 1, further comprising a plurality of counters, wherein the counter update event record includes a COUNTER_ID field including a value that identifies a first counter of the plurality of counters to which the counter update event record applies, wherein the event stream processor is configured to update the first counter in response to the value of the COUNTER_ID field.

3. The multi-core computing system of claim 1, further comprising a port configured to transmit information to an external device, wherein the event stream processor is coupled to the port and is configured to output counter update information through the port.

4. The multi-core computing system of claim 1, wherein the counter update event record includes a TRACE_EVENT_ID field that contains a unique identifier of a trace event that is being written to the trace event register, a TRACE_EVENT_TYPE field that identifies a type of trace event that is being written, a COUNTER_ID field that identifies the counter, and a COUNTER_UPDATE field that provides an amount by which the counter is being updated.

5. The multi-core computing system of claim 1, further comprising a trace event memory coupled to the serialized event stream and the event stream processor, wherein the trace event memory stores counter update event records output in the serialized event stream, and wherein the event stream processor reads counter update event records from the trace event memory.

6. The multi-core computing system of claim 5, further comprising a plurality of counters and a plurality of event stream processors, wherein each of the event stream processors is configured to update a respective subset of the plurality of counters.

7. The multi-core computing system of claim 6, wherein each of the event stream processors is coupled to the trace event memory and is configured to process trace event records associated with its respective predefined subset of the plurality of counters.

8. A method of operating a multi-core computing system including a plurality of processor cores, a trace event register that is accessible by the plurality of processor cores, and at least one counter, comprising:
writing a counter update event record from one of the plurality of processor cores to the trace event register;
serializing the counter update event record in a serialized event stream that is output by the trace event register;
analyzing the counter update event record to determine an identity of a counter that is to be updated and an amount by which the counter is to be updated; and
updating the counter in response to the counter update event record.

9. The method of claim 8, further comprising writing the counter update event record from the serialized event stream into a trace event memory; wherein analyzing the counter update event comprises reading the counter update event record from the trace event memory.

10. The method of claim 8, wherein the multi-core computing system comprises a plurality of counters, and wherein the counter update event record includes a COUNTER_ID field including a value that identifies a first counter of the plurality of counters to which the counter update event record applies.

11. The method of claim 8, wherein the counter update event record includes a TRACE_EVENT_ID field that contains a unique identifier of a trace event record that is being written to the trace event register, a TRACE_EVENT_TYPE field that identifies a type of trace event that is being written, a COUNTER_ID field that identifies the at least one counter that is being updated, and a COUNTER_UPDATE field that provides an amount by which the counter is being updated.

12. The method of claim 1, further comprising:
outputting the counter update event record through a port to an external device.

13. A computing system, comprising:
a plurality of counters;
a plurality of processor cores configured to generate counter update event records that each include a COUNTER_ID field including a value that identifies a first counter of the plurality of counters to which the counter update event record applies and a COUNTER_UPDATE field that provides an amount by which the first counter is being updated;
a register block including a plurality of event registers coupled to the plurality of processor cores, wherein each of the plurality of processor cores is configured to write event records to the event registers, and wherein the register block is configured to generate a serialized event stream including event records written to the event registers; and
an event stream processor configured to read counter update event records from the serialized event stream, to analyze the counter update event records, and to update the first counter in response to the value of the COUNTER_ID field and the value of the COUNTER_UPDATE field in one of the counter update event records.

14. The computing system of claim 13, further comprising a trace event memory coupled to the serialized event stream, wherein the trace event memory stores counter update event records output by the serialized event stream; and
wherein the event stream processor is configured to read the counter update event records from the trace event memory.

15. The computing system of claim 13, further comprising a plurality of event stream processors, wherein each of the event stream processors is configured to update a respective subset of the plurality of counters.
